(19) United States
(12) Patent Application Publication
(10) Pub. No.: US 2026/0213544 A1
(43) Pub. Date: Jul. 23, 2026

(54) ENERGY CONVERTER FOR A RENEWABLE ENERGY GENERATOR

(71) Applicant: KK WIND SOLUTIONS A/S, Ikast (DK)

(72) Inventor: Lorand Bede, Herning (DK)

(21) Appl. No.: 19/139,786

(22) PCT Filed: Nov. 8, 2023
(86) PCT No.: PCT/DK2023/050272

§ 371 Date: Jun. 16, 2025

(30) Foreign Application Priority Data
Dec. 16, 2022 (DK) PA202270622

(51) Int. Cl. H02J 3/38; H02J 7/50; H02J 101/28; H02M 3/155

(52) U.S. Cl. CPC H02J 3/381; H02J 7/50; H02M 3/155; H02J 2101/28

(57) ABSTRACT

An energy converter includes a first and a second battery string which are connected in series with a DC link of a power converter of a renewable energy generator. The battery strings include one or more battery modules controlled by a converter/string controller. The battery modules may be controlled to form the battery string. The battery strings include a plurality of series connected battery modules each including a plurality of connected battery cells and a battery switch module. The battery switch module may include at least two semiconductor switches configured for controlling connectivity of the battery module to the battery string.

### FIELD OF THE INVENTION

The invention relates to an energy converter for a renewable energy generator and a method of control controlling such converter, the converter may be implemented as a dual active bridge DCDC converter comprising switching modules implemented as battery strings comprising controllable battery modules and as a cascaded H-bridge converter with integrated energy storage.

### BACKGROUND OF THE INVENTION

In the art dual active bridge system are well known e.g. from prior art document IN202221021666 which describes energy exchange between the renewable energy source and storage element.

Further, it is known in that art e.g. from WO2022/129249 and CN109004665 to connect a renewable energy source to an electrolyser and use batteries to smoothen the voltage to the electrolyser. This is done by connecting the renewable energy source to the electrolyser and when there is a surplus of energy, the battery is charged. When the renewable energy source does not provide enough energy, the electrolyser is partly supplied from the battery. In this way it may be possible to ensure nominal power to the electrolyser connected to the renewable energy source/battery to ensure stable production.

In the case, the renewable energy source is a wind turbine, the power produced fluctuates e.g. due to wind gust, wake/shadow effects, etc. Also, if the electrolyser is connected to a utility grid, grid disturbances may cause fluctuations in the power delivered to the electrolyser fluctuates which is not desired.

### SUMMARY OF THE INVENTION

The inventors have identified the above-mentioned problems and challenges related to fluctuations in power supply via a dual active bridge DCDC converter (referred to simply as DCDC converter) to an electrolyser. Production, wear and thereby also lifetime of an electrolyser is affected by fluctuations in power supply to the electrolysers. The obvious solution to this problem is to apply a filter on the secondary side of the transformer, however, the inventors have solved this problem differently by replacing switching modules of one of the first and second converter modules with an active controllable battery string as described below.

In an aspect, the invention relates to an energy converter comprising a first battery string and a second battery string, the first battery string comprising a plurality of battery switch modules configured for controlling connection of a plurality of battery modules to the first battery string, and the second battery string comprising a plurality of battery switch modules configured for controlling connection of a plurality of battery modules to the second battery string, wherein a first terminal of the first battery string is configured for being connected to a positive rail of a DC link of a power converter of a renewable energy generator via a first converter terminal, wherein a second terminal of the battery string is connected to a first terminal of the second battery string, and wherein a second terminal of the second battery string is configured for being connected to the negative potential of the DC link via a second converter terminal, wherein a maximum sum of the voltage of the battery modules of the first and second battery strings, is at least equal to a DC link voltage limit, wherein the battery switch module comprises at least two semiconductor switches configured for controlling connectivity of the individual battery modules to the first or second battery string, respectively, wherein a battery string controller is configured for controlling the status of the at least two semiconductor switches of the battery switch module, and wherein the output voltage of the first and second battery strings, is configured for being controlled by the one or more battery string controllers.

Note, that the first battery string may be referred to as the first converter module and the second battery string may be referred to as the second converter module.

In an exemplary embodiment of the invention, said renewable energy generator is a wind turbine or a photovoltaic system.

In an exemplary embodiment of the invention, said energy converter is a cascaded h-bridge converter with energy storage.

In an exemplary embodiment of the invention, said cascaded h-bridge converter with energy storage is connected to an electric load such as a DC load via a second set of converter terminals.

An electric load may be an AC or DC load such as part of an auxiliary system. Hence, in embodiments a reference to a DC load may be a reference to an electric load.

In an exemplary embodiment of the invention, said energy converter is a DCDC converter.

In an exemplary embodiment of the invention, the second terminal of the first battery string is connected to the first terminal of the second battery string via transformer.

In an exemplary embodiment of the invention, the DCDC converter configured for connecting one or more electric loads such as one or more DC power sources to one or more DC loads, said DCDC converter comprising: a first converter module comprising a plurality of first converter module switching modules configured for connecting a first set of converter terminals to a first side of a high frequency transformer, a second converter module comprising one or more second converter switching modules each electrically connected a second side of said high frequency transformer. Wherein the one or more second converter switching modules are electrically connected to at least one second converter terminal set, and a converter controller configured for controlling said first and second converter switching modules. Wherein at least one converter switching module of at least one of said first and second converter modules is implemented as a one or more battery strings, wherein said one or more battery strings each comprises a plurality of series connected battery modules, wherein said battery modules comprising a plurality of connected battery cells and a battery switch module, wherein said battery switch module comprises at least two semiconductor switches configured for controlling connectivity of said battery module to said battery string, and wherein a battery string controller is configured for controlling said four semiconductor switches of said battery switch module.

In an exemplary embodiment of the invention, said battery switch module comprises four semiconductor switches in an H-bridge configuration.

In an exemplary embodiment of the invention, at least one of said one or more second converter switching modules are implemented as one or more battery strings.

Such one or more battery strings may be connected in series to increase available output voltage from the series connected battery strings and/connected in parallel to increase available current output from the paralleled battery strings.

Such DCDC converter is advantageous in that it has the effect, that it facilitates bidirectional current flow between the first and second converter modules and thereby adds flexibility to the power system in which it is implemented. Such flexibility may allow the DC source and DC load connected to the terminal sets of the DCDC converter to change. Thereby, at one point in time, the second converter switching module may act as load i.e. being charged and at a second point in time, the second converter switching module may act as source i.e, supplying power/to the electric system connected to the first set of converter terminals.

It should be mentioned that when referring to a DC load and a DC source this is seen from the DCDC converter. Accordingly, a DC load may in fact be an AC load having a AC/DC converter/inverter connected between the AC load and the DCDC converter. In the same way, a DC load may in fact be an AC load connected to said DCDC converter via an AC/DC converter/rectifier.

In an exemplary embodiment of the invention, said first converter module comprises a first, second, third and fourth first converter switching modules.

In an exemplary embodiment of the invention, said first, second, third and fourth first converter switching modules are implemented as semiconductor switches in an H-bridge configuration.

Compared to a first converter module in which such four first converter switching modules are implemented as battery strings, the semiconductor switch implementation is advantageous in that it is cheaper.

In an exemplary embodiment of the invention, each of said first, second, third and fourth first converter switching modules are implemented as a battery string.

Compared to a first converter module in which such four first converter switching modules are implemented as semiconductor switches, implementation as battery strings is advantageous in that for the same voltage, the battery string implementation is less complicated. Further, compared to the semiconductor switch implementation, the battery string implementation is less prone to system errors. More specifically such errors could be a failing MOSFET, IGBT or other type of semiconductor switch. When such switch is implemented at a battery module the battery module can be bypassed and thereby the converter can continue operation even if a switch is failing. Further, when using battery modules/battery string the voltage is lower enabling the use of lower voltage rated switches making the converter more reliable.

Further, the energy storage capacity of the DCDC converter as such is increased by implementing the first converter switching modules as battery strings. In this way the DCDC converters function as a backup module or as a frequency/voltage regulator module is increased both in terms of available support and in terms of duration support can be provided.

Further, connecting the DCDC converter to a high voltage source (DC or AC) may require some kind of MMC (MMC; Modular Multilevel Converter) like voltage step implementation which may be obtained from the battery modules of the battery strings. Thus, both the voltage step and the energy storage may be provided by the battery string(s).

In an exemplary embodiment of the invention, said first, second, third and fourth first converter switching modules are implemented as a mix of one or more semiconductor switches and one or more battery strings.

This is advantageous in that from such combined implementation the best of the two clean implementations may be obtained.

In an exemplary embodiment of the invention, said at least one converter switching module is comprised by said first converter module, wherein said first converter module is comprised by a wind turbine, and wherein an existing battery string of said wind turbine is used as said at least one converter switching module.

This is advantageous in that a DCDC converter according to the present invention can be retrofitted into an existing electric system already comprising a battery string of interconnectable battery modules the connectivity of which is controllable by semiconductor switches in an H-bridge configuration.

Retrofitting is advantageous in existing system when battery modules of the battery string are controllable via h-bridge, hence from a hardware perspective, nothing need to be changed at the battery string. Only software needs to be updated to allow the battery string to be controlled according to such new implementations in addition to the already existing way of controlling. Such software update may include controlling the H-bridge switches to provide the needed/required voltage for the high frequency AC transformer. Such control may include that instead of running square wave signals on the transformer and thereby have high transformer losses, the transformer losses may be reduced by running a proper AC signal such as e.g. a 1000 Hz signal with steps of 50V (battery module voltage) instead of steps of few hundred volts which typically is the case in known systems.

In an exemplary embodiment of the invention, said second converter switching module is said DC load.

In the situation where an existing battery string-based backup storage is used as/part of the second converter, the DCDC converter in principle could be said to only comprise a first converter module and the high frequency transformer at least from a hardware perspective. This, of course would reduce hardware cost, but would require an update of control software.

In an exemplary embodiment of the invention, said second converter switching module is a battery string configured as power backup for an auxiliary system.

Using an already existing battery string used as backup supply, such as part of an UPS (UPS; Uninterruptible Power Supply), as second converter switching module is advantageous. This is because when such battery string is not in used or when acting as redundant UPS for an auxiliary system the second converter switching module can be utilized as source. In this way the second converter switching module may be assist in maintaining DC link voltage of a power converter and thereby stable output, assist in utility grid stability/electric drive train stability, etc. depending on what is connected to the first set of converter terminals.

In an exemplary embodiment of the invention, said first set of converter terminals is connected to a DC power source and said second set of converter terminals are connected to a DC load.

A DC load may be implemented as a power-to-x plant an auxiliary system of a wind turbine, data center, etc. or the utility grid where the DCDC converter may be used as frequency and/or voltage stabilizing unit just to mention a few examples.

In an exemplary embodiment of the invention, said DC power source is a renewable energy source selected from the list comprising: DC link in power converter of wind turbine, DC output from a wind turbine, electric drive train of a wind turbine, long-term energy storage and DC output from a photovoltaic energy source.

This is advantageous in that it enables the renewable energy source such as wind turbine or photovoltaic energy source to be connected directly to the electrolyser without first being connected to the utility grid. i.e. island mode of operation of the renewable energy source may be facilitated.

It should be mentioned that the DC power source may also occur from a converted AC. Thus, the DCDC converter may be connected to a utility grid via an ACDC converter.

A long-term energy storage may be implemented in the form of a hydrogen storage tank connected to a fuel cell.

In an exemplary embodiment of the invention, said second set of converter terminals are connected to an auxiliary system.

Connecting an auxiliary system to the second set of converter terminals is advantageous in that the DCDC converter may act as backup, supply or regulator for voltage/power required/needed by the auxiliary system.

In an exemplary embodiment of the invention, said auxiliary system is comprised by wind turbine.

This is advantageous in that it has the effect, that already existing battery storages implemented as a battery string acting in an UPS for the auxiliary system may be used as power source to a DC load connected to the first set of converter terminals.

It should be mentioned, that more than one backup supply to more than one auxiliary system may be connected and used as a switching module in either the first or the second converter module.

In an exemplary embodiment of the invention, said auxiliary system is connected to an electric drive train of said wind turbine via a rectifier and/or a transformer.

This is advantageous in that it has the effect, that the battery storage (and thereby at least part of the second converter module) connected to the auxiliary system may be charged by the electric drive train during one period of time. During another period of time, this battery storage may act, via the high frequency transformer and the first converter module, as source for regulating voltage e.g. on the DC link of the power converter of the electric drive train. During another period of time, this battery storage may act as a backup supply for the auxiliary system. Hence, the primary supply to the auxiliary system may be the electric drive system and the backup supply i .. e a secondary supply may be the second converter switching module.

In an exemplary embodiment of the invention, said first converter module is connected to a DC link of power converter of a wind turbine and configured for being controlled by said converter controller to supply power to said DC link.

Using the battery modules of the first converter module and/or of the second converter module to supply power to the DC link is advantageous in that black start of the wind turbine can be supported. This is possible because a battery string is a reliable power source and because it is possible to provide a stable string voltage. In this way diesel generators may be omitted or replaced by battery strings.

Black start may include powering the auxiliary system (i.e. the wind turbine controller, pitch and yaw motors, cooling and lubrication systems, etc.), the DC link of a power converter and the source such as the grid connected to the power converter. It should be noted, that if black start of the turbine or grid should be facilitated it requires sufficient capacity in the battery string(s) to both supply the auxiliary system and build up the DC link voltage.

Accordingly, the DCDC converter may facilitate black start of a wind turbine. A wind turbine with a DCDC converter of the present invention may be able to black start an island network/grid and a plurality of wind turbines with DCDC converter of the present invention may be able to black part of or a whole utility grid. In addition, or as alternative, such wind turbines may also be used to assist in stabilizing operation of the grid.

In an exemplary embodiment of the invention, said energy converter is configured for connecting a DC power source having a positive and a negative potential to a plurality of power-to-x modules

In an exemplary embodiment of the invention, said second converter module comprises a plurality of parallel connected second converter module switching modules each configured for connecting a secondary side of said high frequency transformer to a power-to-x module

A DC power source may e.g. be a grid (AC or DC), DC link of a power converter of a wind turbine, a power to x system such as an electrolyser, etc.

In an exemplary embodiment of the invention, said power-to-x module is an electrolyser module.

It is advantageous to implement the switching modules of either the first and/or the second converter modules with a plurality of battery modules controllable to form a battery string. This is because in this way stable voltage and current and thereby power supply to the electrolyser can be ensured by controlling current flow in/out of the battery modules. Hence, if a dip in power is registered, this can be compensated for by including one or more additional battery modules to the battery string. In the same way, if a power peak is registered, this can be compensated for by charging one or more battery modules. Thereby, the battery string acts as an active filter ensuring high quality of power supply to the electrolyser.

This is especially advantageous in the situation where e.g. a wind turbine is connected to an electrolyser as its own load. In this situation, the electrolyser is the only load and thus, will receive such fluctuations if not removed e.g. by a DCDC converter of the present invention.

Further, in the situation where an electrolyser is supplied from a renewable energy source and the power produced is decreasing. Then, according to prior art systems, a battery may be connected to compensate for the decrease in production. However, connecting a battery when e.g. a voltage supply reaches a certain lower threshold will also introduce disturbances in the supply to the electrolyser. This problem is solved by the introduction of the battery string of controllable battery modules. In that battery support can be ramped in, in steps of one battery module voltage contrary to the prior art where the entire battery is connected in one step.

Accordingly, the present invention does not suggest a separate battery storage that can act as a supply to the electrolyser (which would require a huge and expensive battery storage). Instead, the present invention describes how a battery storage can be integrated in a DCDC converter such as in a dual active bridge system.

Further, connecting each of the switching modules of the second converter module with an electrolyser is advantageous in that minor modules are needed leading to easier service and maintenance. Further, the paralleling of the switching modules of the second converter module ensures that if one electrolyser or one switching module is failing, the remaining may continue to operate.

Note that said first converter module may comprise a first and a second first converter switching module and said first and second first converter switching modules may be implemented as one or more battery strings.

This is advantageous in that it has the effect, that the smoothening of the fluctuations is done on the high voltage low current side of the high frequency transformer. This is advantageous to the lifetime of the battery modules which are less worn out at high voltage and low currents compared to the contrary.

Further, this is advantageous in that the smoothening of voltage to the electrolysers can be made centrally on the primary side contrary to the situation where such control is made on the secondary side, where each electrolyser module may be connected 1:1 with the second converter module switching modules.

In an exemplary embodiment of the invention, battery string voltage output of said one or more battery strings is between 300V and 2000V, such as between 500V and 1500V, such as between 750V and 1250V.

This is advantageous in that it has the effect that high and low voltage ride through situations can at least partly be handled by the battery strings. The battery string output voltage should be understood as the maximum output voltage of battery strings of one or from both of the first and second converter modules. Accordingly, several battery strings may be connected in series and/or in parallel to obtain such battery string voltage.

The battery string voltage is as mentioned established by summing up the voltage of the battery modules included in the battery string. As an example, the voltage of one battery module is around 50V, this if a string voltage of 1000V is required, then 20 battery modules are needed.

To establish redundancy one string controller of a battery string with a required string voltage of 1000V may control 21 or 22 or more battery modules. In this way the string controller is able to compensate for power dip, faulty battery modules and the like.

In an exemplary embodiment of the invention, a sum of battery string voltage of said one or more battery strings correspond to the DC power source.

In case the DC power source is a DC link of a wind turbine converter, the DC power source may be 1000V thus, the sum of the battery string voltage should match the 1000V. As an example, if battery modules each are 50V and there are 10 battery modules in a battery string, then each battery string voltage is 500V and thus, two battery strings are needed.

A match between DC link voltage and battery string voltage preferably exists if the battery string voltage is higher than the DC link voltage. This is because in this way it is possible to control the direction of current in or out of the battery string. Hence if the voltage at the DC link is higher than the battery string voltage, current will run towards the battery string and thereby charge the battery string. In the same way, if the voltage the DC link is lower than the battery string voltage, current will run towards the DC link and the battery string is discharged.

In the situation where more battery modules are available such as 20 battery modules, either one battery string may be used or if the double current and thereby double power is needed two blocks of each 10 battery modules in each string may be connected in parallel.

Accordingly, it is possible to add modules/strings so as to comply with voltages that are higher than the 1000V of the above example.

It should be mentioned, that providing more battery modules in a string than needed or more battery strings than needed will add redundancy and make the DCDC converter more robust to faults and errors.

In an exemplary embodiment of the invention, said second converter module is a DC source leading to said first converter module is connected to a DC load.

In an exemplary embodiment of the invention, said plurality of second converter module switching modules are implemented as semiconductor switches.

Implementing the second converter module switching modules as diodes (a diode may be an example of a semiconductor switch), current may then only be controlled in one direction i.e. towards the electrolyser. However, this will reduce costs of the DCDC converter.

Implementing the second converter switching modules as switches such as IGBTs (an IGBT may be an example of a semiconductor switch), the current may flow bidirectionally between the electrolyser and the DC power source. Hence, if the electrolyser process is reversed, power may be pushed back to the DC power source.

In an exemplary embodiment of the invention, said second converter module comprises one or more second converter module switching module each implemented as a battery string.

This is advantageous in that by adding the battery modules, an energy storage is added and thereby the amount of energy that is possible to push back is increased. In fact, the battery modules of the battery strings may be used as a long-term energy storage.

Further, the energy stored in the battery modules may be used to supply the DC power source while the electrolyser process is reversed and/or supplying the reversed electrolyser process.

It should be noted that reversing the electrolyser process, may be understood as closing down the electrolyser and stating up a fuel cell.

Further, connecting each of a plurality of parallel connected second converter module switching modules, implemented as a battery strings, individually to one electrolyser is advantageous in that in this way the electrolyser is able to draw a high current (which is preferred for the electrolysing process) and at the same time, the voltage over the individual battery strings can be kept low (which is preferred for the battery modules).

In an exemplary embodiment of the invention, said second converter module comprises a plurality of paralleled second converter module switching modules.

Connecting a plurality of second converter module switching modules in parallel is advantageous in that seen as one, this plurality of second converter module switching modules is able to deliver a high power to the connected loads. Thereby the DCDC converter, when seeing the plurality of individual loads connected to the individual second converter module switching modules, as one, is able to supply a load consuming a high power.

In an exemplary embodiment of the invention, switching modules of both of said first and second converter modules are implemented as one or more battery strings.

This is advantageous in that the DCDC converter then is able to both smoothen voltage/power supply to the electrolyser and being able to push power back to the DC power source.

In an exemplary embodiment of the invention, said first converter module is configured to convert a DC voltage from said DC power source to an AC voltage supply to said primary side of said high frequency transformer.

Accordingly, the first converter module i.e. the first and second switching modules may be considered a DCAC converter which is advantageous in that the high frequency transformer can be inserted between the first and second converter modules and facilitate isolation of the DC power source connected to the first converter module and the electrolyser modules connected to the second converter module.

In an exemplary embodiment of the invention, said second converter module is configured to convert an AC voltage from said secondary side of said high frequency transformer to a plurality of individually controllable DC voltage supplies to a plurality of electrolyser modules.

Accordingly, the second converter module i.e. the second converter module switching module may be considered an ACDC converter which is advantageous in that is assist in establishing a galvanic separation between the DC power source and the electrolyser modules.

In an exemplary embodiment of the invention, a fuel cell is electrically connected to said second converter module switching module, thereby being able to feed power back to said first converter module.

This is advantageous in that in this way a huge power backup is established. Such power supply may be supported by the battery strings so that also in this situation a stable supply can be established. Such power supply could e.g. be a wind turbine that is not grid connected yet, it could be a data center, etc.

In an exemplary embodiment of the invention, said high frequency transformer is a step-down transformer having a ratio between 1:15 and 1:5, such as 1:10.

A high frequency transformer is advantageous to insert between the first and second converter modules in that it establishes a galvanic separation between the power supply to the DCDC converter and the load connected to the DCDC converter. Thereby it is possible to ground the load connected to the second converter module without paying attention to the potential of the power source connected to the first converter module.

A ratio such as 1:10 is advantageous in that the primary side of the high frequency transformer may be suitable for connecting e.g. to a DC link of a wind turbine converter having a voltage in the range of 1000V. The secondary side of the high frequency transformer is suitable for connecting to e.g. a battery string comprising battery modules having battery module voltages in the range of 50V. Hence, together two such battery modules may have a battery module voltage of 100V.

Because both the primary and secondary sides of the high frequency transformer is connectable to battery strings the voltage of which is controllable in steps of one battery module voltage, the voltage on the primary and on the secondary sides is typically relatively stable.

The high frequency transformer is advantageous in that it can be made physically smaller than a standard transformer having the same electrical specifications.

In an exemplary embodiment of the invention, a converter controller is configured for providing control reference signals to one or more string controllers, wherein said one or more string controllers are configured for controlling switching modules of said first converter module and of said second converter module.

The switches of the switching modules of the first and second converter modules may as mentioned be implemented as battery strings. Hence, a controller controlling a switching module may therefore control a battery string. Therefore, such controller may be referred to as a string controller. The switches of the switching modules may therefore be controlled be a string controller or one string controller may control the switches of the a first switching module and another string controller may control switches of a second switching module. Such control may be done based on reference signals received from a converter controller which preferably is communicating with all string controllers of the converter.

In an exemplary embodiment of the invention, said battery cells of said battery module are connected in series, in parallel or in a combination of series and parallel.

The connection of battery cells in a battery module is fixed i.e. not dynamic as is the case with the interconnection of battery modules in a battery string. Hence, the battery cells are typically connected in series (to establish a desired voltage over the connected battery cells which also is referred to as the battery module voltage). Alternatively, the battery cells may be connected in parallel or two or more cells may be connected in parallel which then again may be connected in series with remaining battery cells (to adjust the capacity and voltage of the battery module).

In an exemplary embodiment of the invention, said battery string comprises at least two independent battery strings connected in parallel.

Connecting two or more battery strings in parallel is advantageous in that it has the effect, that the current possible to deliver is increased. Accordingly, with reference to FIG. 6 if the two battery strings may each comprise two or more series connected battery strings.

In the case the converter is connected to DC link of a power converter of a wind turbine. The number of paralleled battery strings may be determined by the nominal power which can be delivered by the wind turbine, e.g. 2 MW in case of a 2 MW wind turbine. This is advantageous in that it has the effect, that the inrush current is reduced when the power converter is connected to grid. Further, it is advantageous in that it has the effect, that a power boost from the wind turbine higher than nominal power production may be delivered for a short period of time.

In an exemplary embodiment of the invention, each individual battery string comprises a battery string controller configured for controlling connectivity of battery modules of said individual battery string to said battery strings.

Hence, with reference to FIG. 6 if the two battery strings each comprise two battery modules in parallel, a total of four battery string controllers are needed. In addition, a converter controller may be needed to coordinate the control of the battery switch modules and thereby of the output voltage and current from the individual battery strings and thus from the battery strings illustrated in FIG. 6.

In an exemplary embodiment of the invention, at least one battery string of said energy converter is configured for supplying a current to a DC link of a power converter and thereby facilitates creating a power loss in said power converter.

This is advantageous in that it has the effect that heat is generated and thus the power converter is dried out. More specifically, the grid and/or converter side inverter/rectifier of the converter is circulating the current either with a passive power converter controller (negative voltage from battery string to negative potential of DC link). Alternatively, assisted by the power converter controller (positive voltage from battery string to positive of DC link).

In an exemplary embodiment of the invention, the energy converter according to any of the claims 1-41 implementing a method according to any of the claims 43-49.

Moreover, an aspect of the invention relates to a method of controlling a DCDC converter connecting a DC power sources to one or more DC loads via a high frequency transformer, said DCDC converter comprising: a first converter module comprising at least two individually controllable battery modules electrically connecting said DC source to a first side of said high frequency transformer. A second converter module comprising a battery string comprising a plurality of individually controllable battery modules electrically connecting said one or more DC loads to a second side of said high frequency transformer. A converter controller providing control references to a string controller based on which said string controller is controlling connectivity of said plurality of battery modules of said second converter modules to said battery string. Wherein said connectivity is established by controlling semiconductor switches in a battery switch module of the individual battery module of said plurality of battery modules.

This is advantageous in that it has the effect, that DC loads such as electrolyser modules supplied by individual battery modules can be individual connectable to the DC source including bypassed if needed. Further, this is advantageous in that it has the effect, that a number of the plurality of battery modules may be controlled to supply one larger (compared to loads supplied from a signal battery module) DC load.

In an exemplary embodiment of the invention, said semiconductor switches are configured in an H-bridge.

In an exemplary embodiment of the invention, said at least two battery modules are implemented as battery strings.

Implementing the two battery modules as two individual battery strings is advantageous in that larger voltage, frequency and/or power range related to grid support may be provided, redundancy is provided i.e. one module may be bypassed without interrupting the operation of the DCDC converter, etc.

In an exemplary embodiment of the invention, said battery modules of said battery strings are controlled to supply power to said DC source.

This is advantageous in that black start of the DC source is facilitated.

In an exemplary embodiment of the invention, said string controller enable control charge of said DC link to any voltage between 0 and maximum battery string voltage.

A closed loop voltage control is advantageous in that it has the effect, that the voltage with which the DC link can be charge can be regulated in discontinuous steps approaching continuous regulation. This is true if e.g. Pulse Width Modulation is used, if not the discontinuous steps would be in steps of one battery module voltage. Such flexible DC link charge voltage control is advantageous in that it enables shaping and maintaining an output from the wind turbine and thereby enable island mode operation (as alternative to grid following wind turbines) and black start of a wind turbine. Further, it enables inrush current reduction when connecting the wind turbine to the grid. Further, it enables pre-charge of loads and absorption in case of voltage fault (high or low) ride through, short time power boost (high etc.

Note that more typically one battery string is controlled by one battery string controller and thus a converter controller may act as a master controller for a plurality of battery string controllers in case there are more than one battery string (e.g. in series or parallel).

In an exemplary embodiment of the invention, at least battery modules of said first converter module is charged from said DC link during idle mode of a wind turbine.

This is advantageous in that it has the effect, that energy produced by an idling wind turbine is used for charging battery modules which then do not need to be charged from the grid or from the wind turbine when it is producing energy to the grid or to a load.

In an exemplary embodiment of the invention, at least one of said battery modules is bypassed.

Bypassing a battery module is advantageous in that it has the effect, that if one of the electrolyses modules is failing, the remaining electrolyser modules are able to continue producing hydrogen. The same is true for battery modules, if one fails the operation of the DCDC converter may continue based on the remaining battery modules.

Further, the possibility of bypassing one of the battery modules also allows to scale the current drawn from the secondary side of the high voltage transformer i.e. the current from the remaining modules would increase.

Moreover, the invention relates to an energy converter according to any of the claims 1-41, controlled according to the method of any of the claims 43-49.

Moreover, the invention relates to a DCDC converter configured for connecting one or more DC power sources to one or more DC loads, said DCDC converter comprising: a first converter module comprising a plurality of first converter module switching modules configured for connecting a first set of converter terminals to a first side of a high frequency transformer, a second converter module comprising one or more second converter switching modules each electrically connected a second side of said high frequency transformer, wherein said one or more second converter switching modules are electrically connected to at least one second converter terminal set, and a converter controller configured for controlling said first and second converter switching modules wherein at least one converter switching module of at least one of said first and second converter modules is implemented as a one or more battery strings, wherein said one or more battery strings each comprises a plurality of series connected battery modules, wherein said battery modules comprising a plurality of connected battery cells and a battery switch module, wherein said battery switch module comprises at least two semiconductor switches configured for controlling connectivity of said battery module to said battery string, and wherein a battery string controller is configured for controlling said four semiconductor switches of said battery switch module.

Moreover, the invention relates to a DCDC converter according to claim 51 implementing features selected from at least one of the claims 5-41.

Moreover, the invention relates to a DCDC converter according to claim 52 controlled according to the method of any of the claims 43-49.

### THE DRAWINGS

For a more complete understanding of this disclosure, reference is now made to the following brief description, taken in connection with the accompanying drawings and detailed description, wherein like reference numerals represent like parts. The drawings illustrate embodiment of the invention and elements of different drawings can be combined within the scope of the invention:

FIG. 1 illustrates a converter according to the invention,

FIG. 2a-2c illustrates various implementations of the first converter module of the converter,

FIG. 3a-3b illustrates various implementations of the second converter module of the converter,

FIG. 4a-4b illustrates various implementations of a battery string,

FIG. 5 illustrates an implementation of DCDC a converter in a wind turbine, and

FIG. 6 illustrates an implementation of a cascaded H-bridge converter with integrated energy storage.

### DETAILED DESCRIPTION

The present invention is described in view of exemplary embodiments only intended to illustrate the principles and some implementations of the present invention. The skilled person will be able to provide several embodiments within the scope of the claims.

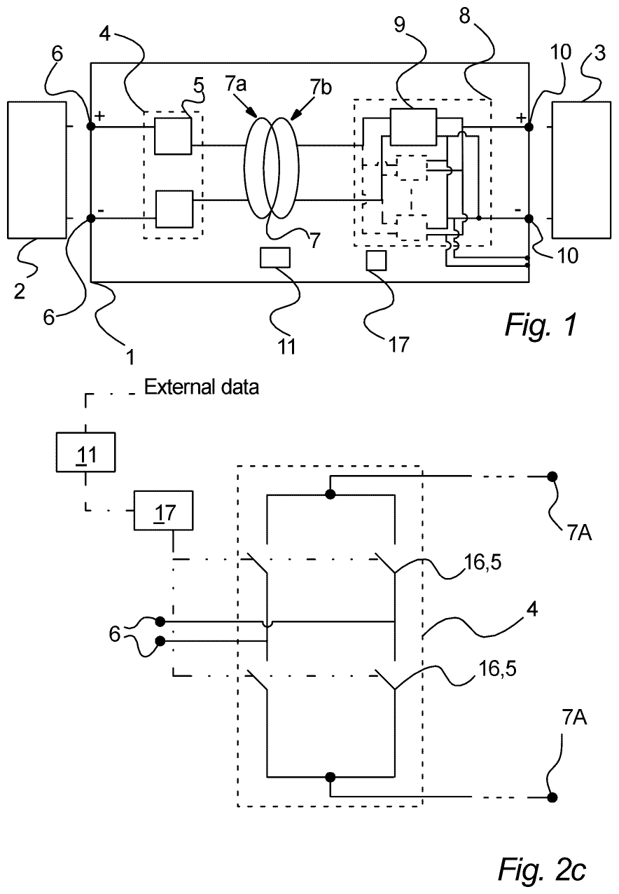

FIG. 1 illustrates a converter 1 (sometimes referred to as an energy converter, DCDC converter or cascaded H-bridge converter) according to an embodiment of the invention. The main components of the converter are a first converter module 4, a high frequency transformer 7 and a second converter module 8. The converter 1 comprises a first set of terminals 6 to which a DC power source is connected and a second set of terminals 10 to which a DC load is connected. These terminals are labelled “+” and “−” indicating DC potentials, however these potentials may of course be changed.

As will be clear from the description below at least part of one of the first and second converter modules 4, 8 is implemented as a plurality of battery modules 13 connected in a battery string 12. The higher number of battery strings 12 and the higher capacity of such battery strings 12, the more services/functions the converter 1 is able to provide in terms of voltage and/or power balancing (towards the source 2 or towards the load 3), power backup, etc.

The high frequency transformer 7 (sometimes referred to simply as HF transformer) may in principle be any kind of HF transformer designed to handle the voltage and current specified for the application in which the converter 1 is used. This may include voltage levels from a few hundreds and up to a few kilovolts such as up to 5 kV. The transformer is referred to as a high frequency transformer because of its high working frequency which is typically from around 1 kHz and up.

A HF transformer is preferred because it is smaller in size compared to non-HF transformer. This is true even though a HF transformer requires a drive circuit as the first and second converter modules 4, 8 described below. Generally speaking, the size of the transformer is reduced as the frequency is increased. This also indicates, that if there is no limit to the footprint of the transformer, even though referred to as a HF transformer, the transformer may not necessarily by a HF transformer.

With this said the HF transformer is preferred e.g. due to the lower losses occurring in the copper wires of the windings, the mass of which is reduced in size with the size of the transformer increasing the efficiency of the transformer. As other transformers, the HF transformer also provides a galvanic separation between the source 2 and the load 3.

The DC power source 2 connected to the first set of converter terminals 6 may either be a “real” DC source or an AC source which is rectified. Thus, there are in principle no limits to the type of power source 2 that is connected to the converter 1. However, it is easier to establish the needed high frequency voltage to the HF transformer 7 from a DC supply than from an AC supply. It is not impossible to supply an AC directly to the first converter module 4 and then establish the high frequency voltage, it is just more complicated than if the supply is DC.

Examples of a “real” DC source may e.g. be one or more photovoltaic panels the output of which is DC, a wind turbine with a DC generator or the like.

Example of an AC source which is rectified may be e.g. a wind turbine with an AC generator and a back-to-back power converter where the DCDC converter 1 is connected to the DC link of the power converter. Another example could be a utility grid acting as supply to the DCDC converter 1. It should be noted that in principles, the converter 1 may be connected.

The DC load 3 (sometimes referred to simply as a load) connected to the second set of converter terminals 10 may in principle be any kind of load. In an embodiment, the load 2 is a power-to-x generator such as an electrolyser for producing hydrogen. In another embodiment, the converter 1 is acting as a backup supply hence the load may be any kind of load (AC or DC) requiring backup in case its main supply fail. An example of such load could be the auxiliary system of a wind turbine i.e. controllers, motors, cooling/heating systems, etc.

It should be noted, that in fact, the converter 1 may be connected to various types of loads such as an electrolyser and at the same time an auxiliary system of a wind turbine. This would require that the second converter module 8 is implemented as one or more battery strings and that the converter 1 comprises two or more sets of second terminals 10.

The converter controller 11 is coordinating the control of the DCDC converter 1 e.g. with input from external data sources such as electric systems external to the DCDC converter 1 such as grid/grid operator, energy markets, metrological databases, etc. But also internal information such state of health of a load 3 or battery module 13 may be used in determination of a control strategy. Further, information from sensors (such as current and voltage) and from components (such as temperature) ambient temperature humidity etc. is retrieved or established by the controller. Based on such information and information of the currents state of the DCDC converter elements a control strategy is determined by the converter controller 11. Such strategy may include facilitate grid support, supply load, pause operation of one or more loads 3, etc.

Via communication with the string controller(s) 17 controlling battery switch modules 15 the control strategy is implemented. Typically, one string controller to one string. Hence it is the string controller 17 which is controlling the switches 16 of the switching modules 15 and thereby power flow in the DCDC converter1, which load(s) should be supplied, etc. Further, the string controller is also controlling the switches to include battery modules in the string e.g. depending on state of charge, state of health or the like. Accordingly, the converter controller, the string controllers and maybe external controller or input from external controllers or data reference are used together to control the converter 1. External references may include information from the grid to which the power converter 20 of which the converter 1 is connected. Such information may be frequency, voltage, etc.

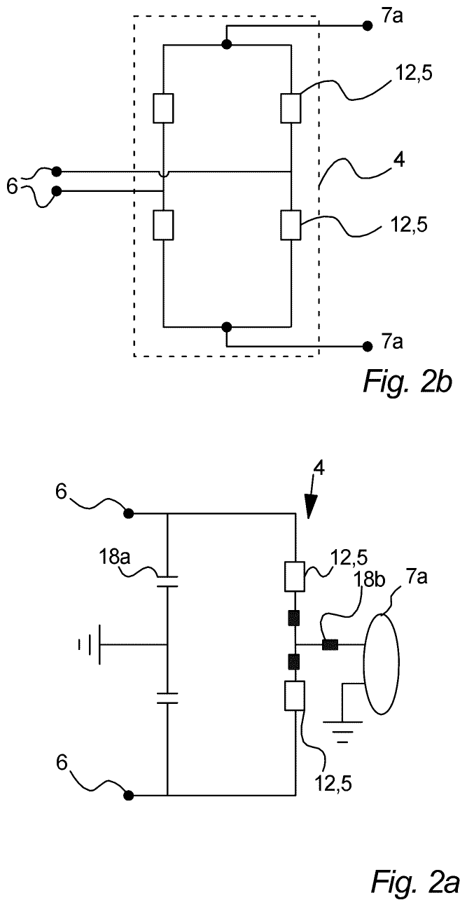

The first converter module 4, acting as a drive for the HF transformer, may be implemented in various designs as indicated in FIG. 2a-2c.

One way is to implement two first converter module switching modules 5 as battery strings 12 where the battery strings are connected to the first set of terminals 6 and the primary side of the HF transformer 7a. This implementation is illustrated FIG. 2a where two battery string 12, each having e.g. 20 battery modules 13 are connected in series. The battery strings 12 are connected to the first set of terminals 6 and split into two by grounding the midpoint as illustrated. In this way, even if the DC source 2 is 2000V, each of the battery strings 12 will only “see” 1000V. In this way requirements to isolation of the printed circuit board comprising the battery switch modules 15 is reduced and higher output voltage of the first converter module 4 can be achieve. This particular embodiment may be used for connecting to a DC source 2 in the form of a DC link of a power converter of a wind turbine having between 1100V and 1300V DC link voltage.

It should be mentioned that as illustrated additional electric components 18 such as capacitors 18a and inductors 18b may be required. This is true for both the design illustrated in FIG. 2b but may also be true for other designs even though such electric components 18 are not illustrated.

The voltage and frequency hereof in the midpoint of the two battery strings 12 can be controlled as desired (within the limits of the battery modules). This may result in e.g. a 1500V, 1 kHz voltage in this midpoint. This midpoint between the two battery strings 12 is connected to the HF transformer 7 which may be 500 Hz or above.

The ratio of the transformer may be decided/selected to comply with the requirements specified by the DC load 3 connected to the second set of converter terminals 10. In case the load 3 is an electrolyser unit, a voltage of e.g. 150V would be an acceptable output from the HF transformer 7. Further, as electrolysers requires high current, a HF transformer 7 in the form of a step-down transformer stepping the voltage down from e.g. the 1500V to 150V (lead to current on secondary side 10 times higher than on input side) would be suitable if the converter 1 is connected to a 1000V source 2 and one or more loads 3 in the form of electrolyser(s). As will be described below, a number of electrolyser modules may be connected in parallel, the number may be decided by the available current from the source 2.

Implementing the first converter module switching modules 5 as strings 12 of battery modules 13 comprising battery switching modules 15 as described below is advantageous in that peak shaving can be achieved. Hence, by control of the battery switching modules 15 the battery modules 13 may act as a filter smoothening the power supplied from the source 2. This is especially advantageous if loads are connected to the converter 1 requiring or performing best with constant voltage/power supply. An example is b if electrolysers are connected to the second set of terminals 10 in that electrolysers operates best and with least wear if connected to a stable/constant voltage /ower supply.

In addition to the first converter module switching modules 5 also the second converter module switching modules 9 may be implemented as battery modules 13/battery strings 12. In this case, the above advantages may also be achieved by implementing the second converter module as battery modules 13/battery strings 12 or by a combination of battery modules/strings on both sides of the Hf transformer 7.

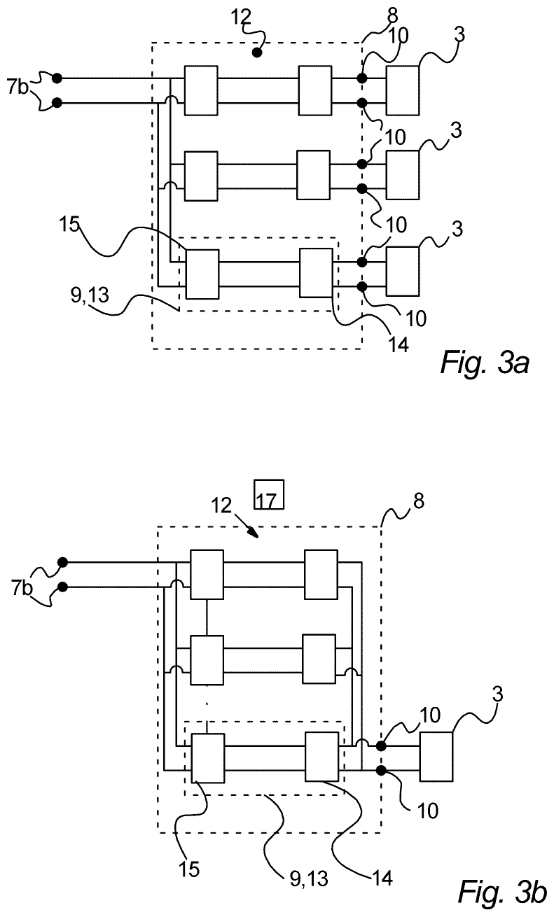

Such second converter module switching modules 9 are illustrated in FIGS. 3a and 3b. If the converter 1 comprises a first module 4 as illustrated in 2b (full bridge) and a second module 8 as illustrated in FIG. 3a or 3b the converter 1 allows reverse power flow (from second converter module 8 side to first converter module side 5).

Accordingly, if the load 3 or one of a plurality of connected loads 3 is a fuel cell, then power produced from such fuel cell can be pushed back via the HF transformer 7 and the first converter module 4 to the source 2. If the source 2 is the grid, the converter 1 can assist in grid support operations or simply supply power to the grid.

Further, if a fuel cell is electrically connected to the converter 1 and a hydrogen storage is fluidly connected to the fuel cell. The converter 1 is able to work as a renewable power generator. Thus, if connected to a wind turbine, the wind turbine will be able to produce power and supply power to the grid even if the wind speed is below cut-in speed.

FIG. 2b illustrates a design of the first converter module 4 where the first converter module switching modules are implemented four battery strings 12. Implementing the first converter module 4 as a full bridge, it is possible to establish high (+), low (−) and zero voltage whereas if it is implemented as a half bridge it is only possible to establish high (+) and low (−) voltage.

FIG. 2c illustrates a traditional design where the first converter switching modules 5 are implemented as four active semiconductor switches 16 connected in an H-bridge configuration. Such implementation could e.g. be based on known MMC principles. This implementation is advantageous in that it does not require any battery modules thus, no extra components, weight or control compared to implementation of battery strings.

When such simple first converter module 4 is combined with a second converter module 8 comprising battery modules 13 at least part of the advantages of the converter 1 is maintained.

It should be noted that the first converter module switching modules 5 may be implemented as described above, with two active semiconductor switches 16 or with a combination of active semiconductor switches 16 and battery modules 13/strings 12 such as two switches 16 and two strings 12.

The converter controller is illustrated as connected to external data and to the string controller 11. The string controller 11 is connected to the switches 16 via gate drives and to not illustrated battery monitoring systems and other relevant hardware of the battery modules 13 relevant to the control of the switches 16.

In FIGS. 3a and 3b, the second converter module 8 is connected to the secondary side of the HF transformer 7b and to the second set of terminals 10. If only flow of current is required in one direction such as from the HF transformer 7 to the second set of terminals 10 the second converter module switching module(s) 9 may be implemented as passive semiconductor switches such as diodes. In this figure no controllers are illustrated, however a string controller 17 is needed if not the converter controller 11 is able to control the switches 16 of the battery modules 13.

If bidirectional flow of current is required between the HF transformer 7 and the second set of terminals 10 the second converter module switching module 9 may be implemented as active semiconductor switches such as MOSFETs or IGBTs.

A combination of the above-described first converter module 4 and a second converter module 8 with passive or active semiconductor switches may provide the above-mentioned advantages.

However, implementing the second converter module switching modules 9 as battery modules 13, preferably as one or more string 12 of battery modules 13 is advantageous in that e.g. the load 3 can be supplied even without power is supplied from the source 2. Further, in this design the converter 1 may act as a long-term energy storage.

In FIG. 3a, a plurality (three in this figure, but could be many more) of battery modules 13 are connected in a battery string 12. In the illustration on FIG. 3a, each of the battery modules 13 are connected to a set of second terminals 10. To each of these sets of second terminals 10, a load e.g. in the form of an electrolyser is connected. The battery modules 13 are interconnected by the battery switching module 15 forming the string 12.

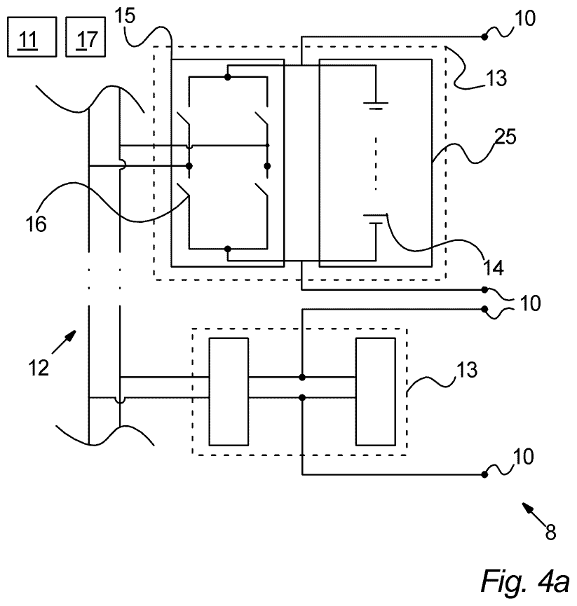

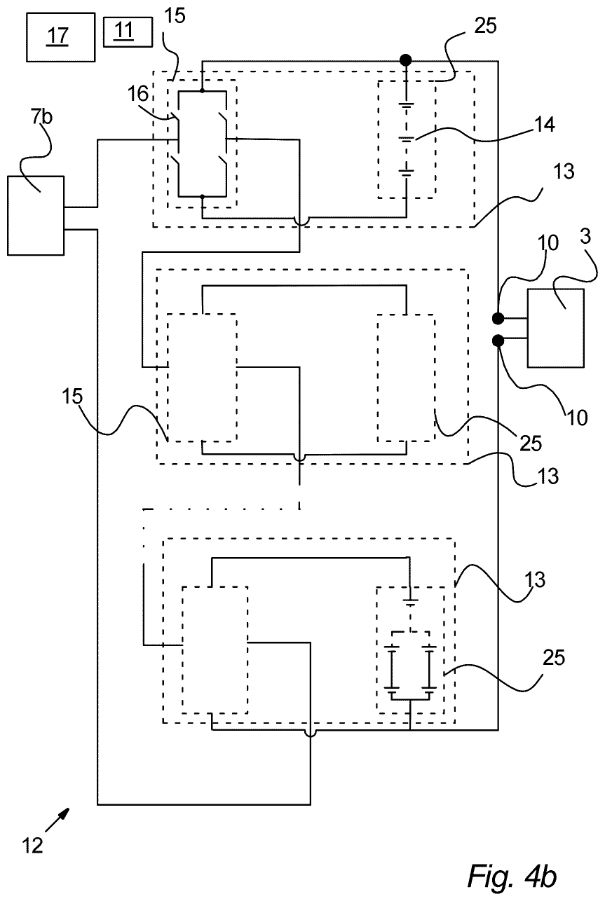

This string design has the drawback of not being able to control the current supplied to the load 3 very vell. This is however possible by the string design illustrated in FIG. 4b.

The battery switching module 15 facilitates bypass of an individual battery module 13/load 3. Bypass is advantageous in the situation where a battery module / load fails, then the converter 1 may continue operation just without the failing battery module/load. Accordingly, if one electrolyser (load 3) fails, hydrogen production can be maintained via the remaining electrolysers.

The capacity of the battery modules 13 may be limited so as only to support a primary supply from the HF transformer 7 or high so as to be able to supply the load 3 without the primary supply (at least for a period of time).

FIG. 3b also illustrates a battery string 12. The battery modules 13 are connected in parallel thereby facilitating the supply of one larger load such as one larger electrolyser.

Note that the first and second converter modules illustrated in FIGS. 2a-2c and 3a-3b may be combined so that the first converter module illustrated in FIGS. 2a-2c may be similar or partly similar to the second converter module illustrated in FIGS. 3a-3b and vice versa.

FIGS. 4a and 4b illustrates a battery module 13 in further details. The battery module 13 illustrated in FIGS. 4a and 4b are the same, it is the implementation of battery modules 13 in the string 12 that is different. Both the illustrated designs are advantageous in that they provide a high degree of redundancy. Hence, if one part of a battery module 13 fails, the particular battery module 13 may be bypass and the remaining may continue to operator. In the same way, if one load fail, the remaining loads may continue operation. Accordingly, the DCDC converter 1 of the present invention provides a flexible solution to supply load(s) such as electrolyser(s) from a power source.

The battery module 13 illustrated in FIG. 4a comprise a battery switching module 15 and a plurality of battery cells 14. The battery modules 13 are interconnected to form the battery string 12 via the battery switching module 15. In the embodiment where the full potential of the battery modules is fully exploited, the battery switching module 15 comprises four semiconductor switches 16 in a H-bridge (full-bridge) configuration. This allows current flow to and from battery cells 14 and bypass of the battery cells 14. Further, it allows, by controlling the battery switching module 15 of a plurality of battery modules 13, the establishing of both DC and AC voltage and associated current from the string 12 of battery modules 13.

In FIG. 4a, the battery modules 13 are connected in the string 12 via the midpoint of the switches 16 in the H-bridge. The battery cell 14 are connected to the H-bridge between the two legs of the H-bridge. Alternatively, the connection between the modules 13 and between the switching module 15 and cells 14 may be opposite the illustration in FIG. 4a.

The switches 16 may in principle be any kind of semiconductor switches including MOSFETs and IGBTs. The switches 16 may be implemented on a printed circuit board (PCB; Printed Circuit Board) allowing mass production. Further, since such PCBs are identical any battery pack 25 (i.e. electrically connected battery cells 14) may be controlled by any such PCB leasing to easy mounting and replacement of the battery modules.

The battery pack 25 include as illustrated battery cells 14 that may be connected in series. However, other configurations of the battery cells 14 may be possible such as connecting them in parallel or establishing two or more sets of series connected cells which then are connected in parallel. Accordingly, the battery pack 25 may be designed for the application in which it is used i.e. with focus on capacity, high output voltage, etc.

As indicated by the lines ending at the second set of terminals 10, in this design of the second converter module 8 each battery module 13 is connected to an individual load 3. The advantages and disadvantages of such design are described above.

Also as indicated above the battery modules 13 may be paralleled and connected to one common load 3 (see FIG. 3b).

The string 12 illustrated in 4b solves the problem of current control present in the design illustrated in FIG. 4a. The battery modules 13 are series connected via the switch modules 15 thereby allowing bypass of one battery pack 25 i.e. no contribution from this to the current output of the battery string 12 is provided.

The battery pack 25 of the lower most battery module 13 illustrate two sets of series connected battery cells 14 that are connected in parallel. In addition, these paralleled cells 14 are connected in series with an additional cell 14. This is to illustrate that the battery cells 14 may be connected in various configurations in a battery pack 25.

The converter controller 11 and the string controller 17 are illustrated to underline, that in this embodiment they are used to control the switches 16 and thereby the configuration of the battery string 12. It should be noted that such control may include change of polarity of one single module 13.

The stipulated lines between battery modules 13 and battery cells 14 serves to indicated that the number of modules 13 and cells 14 may be higher than what is illustrated.

Only one load 3 is illustrated as connected to the string 12 via the second set of output terminals 10. However, it should be mentioned that one load 3 may be connected to one battery module also in this design.

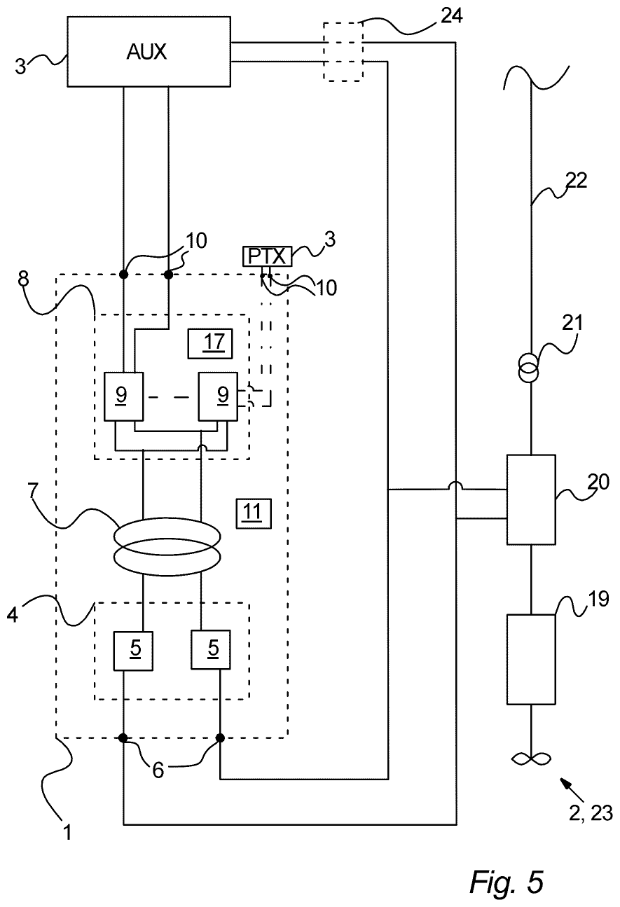

FIG. 5 illustrates an embodiment where the converter 1 according to the invention is implemented in a wind turbine 23. Accordingly, the source 2 in this embodiment is the wind turbine 23. The first set of terminals 6 may be connected to the wind turbine 23 at the DC link of the power converter 20. It should be mentioned, that it may also be connected at least at the following positions of the electric drive train: between the generator 19 and the power converter 20, between the power converter 20 and before or after a switchgear/transformer 21 connecting the power converter 20 to the grid 22 and to the grid. As these sources are both DC and AC, the different connection options may require additional rectifier DCDC converter, switches etc. which are not illustrated.

Depending on type of voltage supply, the first converter module 4 may be designed as a half or full bridge e.g. according to the designs described above with reference to FIGS. 1 and 2a-2c.

The design of the second converter module 8 may be as described above according to FIGS. 1 and 3a-3b. The stipulated line between the second converter modules 9 indicates, that these may be implemented by several e.g. battery modules 13.

In the embodiment illustrated in FIG. 5, two sets of second converter terminals 10 are illustrated. A first set is connecting the converter 1 to an auxiliary system (AUX; AUxiliary System) 3 and a second set is connecting the converter 1 to a power-to-x (PTX) unit such as an electrolyser 3. Thus, the design of the second converter module 8 may facilitate simultaneous supply of the auxiliary system and of the electrolyser.

During normal operation, the AUX 3 is supplied from what is referred to as main supply i.e. either from the grid/wind turbine. A DCDC converter 24 is illustrated to converter the DC voltage level of the DC link of the power converter 20 to the DC level of the AUX 3. As indicated above, if the AUX should be supplied with AC, then an DCAC converter may be implemented instead, or the supply may be provided directly from an AC source. Further, note that even though not illustrated, the PTX 10 module may also be supplied from the main supply. Further, battery modules of the converter module(s) 4, 8 may also be charged from the main supply. The supply to the AUX 3 and DCDC converter 1 does not need to be the same i.e. the Aux may be supplied from the wind turbine and the DCDC converter may be supplied from the grid (this would require different electric connections than illustrated in FIG. 5). This means, that a PTX 3 unit may be powered from the DCDC converter 1 (or from the main supply (electric connection thereto is not illustrated)) and producing e.g. hydrogen independent of whether or not there is wind above cut-in wind speed.

It should be mentioned that connection of the DCDC converter 1 to the main supply may require a rectifier if e.g. the DCDC converter is connected to the AC grid.

Further, it should be mentioned, that the DCDC converter may also facilitate grid support in various forms. In case the second converter module switching modules 9 are implemented as battery modules. Grid support would require communication between the converter controller 11 and a grid operator (sensor, controller, and the like) and in response to e.g. a voltage dip, the DCDC controller/battery string controller 17 may control the second converter module 8 (and the first 4 if this is also implemented as battery modules) to establish a voltage allowing a current to flow to the grid for a shorter or longer time in dependency of the capacity of the battery module thereof. The main supply may not fail completely for the DCDC converter 1 to facilitate support. Hence, the wind turbine may operate normal while the grid may be faulty or vice versa, in both situations, the DCDC converter 1 may facilitate support to the faulty part.

Grid support can be facilitated in multiple ways. Below is described a couple of examples with reference to a wind turbine, but they may also apply if the power source 2 is not a wind turbine. In case of e.g. a low voltage ride through event, the excess energy can be pushed to the batteries instead of being burned off. Accordingly, batteries of the DCDC converter can be charged during such low voltage rid through even. Further, grid support can be in the form of providing extra active power from the batteries in case the grid frequency is dropping.

Additionally, grid support may be provided in the form of black start of the grid. This may be provided by the batteries which could provide power to the wind turbine to start up the grid and act as a power balancing unit. In general, the load of the grid cannot be controlled. Thus, in every instance the power generated by the wind turbine (and leaving the turbine) has to be the same as the consumed power. Since the wind speed will not change just because the load changed, the battery modules 13 could balance out this power difference between the load and the generator.

Also it should be mentioned that black start may also include black start of the wind turbine. Hence, during black start it might be required that the DC link of the power converter of the wind turbine is charged up prior to the blades of the wind turbine starts to rotate. Such DC link charge may also be powered from the battery modules 13 of the DCDC converter.

If the main supply fail, the supply of the AUX 3 is changed from the main supply to the DCDC converter 1 of the present invention. If production of the PTX 3 is on, this production may be shut off at least for a period of time to ensure sufficient capacity to supply the AUX 3 (also in the future).

Hydrogen produced by the PTC 10 may be stored in a tube trailer or in a stationary storage. A compressor may be used to increase pressure in such storage/trailer to be able to store more hydrogen molecules in the same storage. Alternatively, a pipeline may connect the PTX 10 to a central storage.

The DCDC converter 1 may not only facilitate support in case of failure of e.g. the wind turbine. E.g. in case the wind turbine for some reason is electrically disconnected to the grid and need to start-up without such grid connection, the DCDC converter may act as power source for such black start. Alternatively, the DCDC converter 1 may help the wind turbine perform black start of the grid 22.

Accordingly, since in one embodiment there is a connection between the second module 8 and the DC link of the power converter 20. The battery modules e.g. of the second module 8 is connected to the DC link via the transformer 7 and the first module 4 or the second module is connected to the DC link via a direct not illustrated electric connection. The second module 8 may operate as backup system. Accordingly, at least the battery modules of the second module 8 is able to help the wind turbine 23 perform black start of the grid 22. Hence, the battery modules would provide power balancing coming from the wind and/or be able to filter out the power fluctuations coming from the grid (such fluctuations may come from loads of the grid being turned on and off), and also help in black starting the whole wind turbine 23 and not just the AUX 3, since it would be possible to provide power to the entire electric drive train and thereby assist to start operation. Further, the battery modules of the second module 8 may be used to pre-charge the DC link capacitors and/or loads 3 if needed. It may be required to provide additional battery modules such as a secondary or third battery string and connect the first, second and/or third strings in series to reach the DC link voltage.

It should be mentioned that one cascaded H-bridge converter such as a one or more battery strings connected to the DC link may in some cases be sufficient to enable at least some of the features or at least part of some of the features presented in this document. However, for reasons of implementation, control, footprint, etc. it is often preferred to have two or more series connected battery strings.

So, in principle the DCDC converter 1 may be used to perform black start of aux system 3 and/or entire wind turbine 23 and because of this, it is also able to assist in black start of a grid 22. One wind turbine would only be able to assist in black start of a local/island grid and a high number of wind turbines would be able to contribute to black start of a larger grid.

It should be mentioned that if e.g. a wind turbine or solar system already comprise a battery string 12 with controllable battery modules 13 as described above, i.e. connected directly to the DC link of the power converter, such existing battery string may be included as part of a DCDC converter as described above.

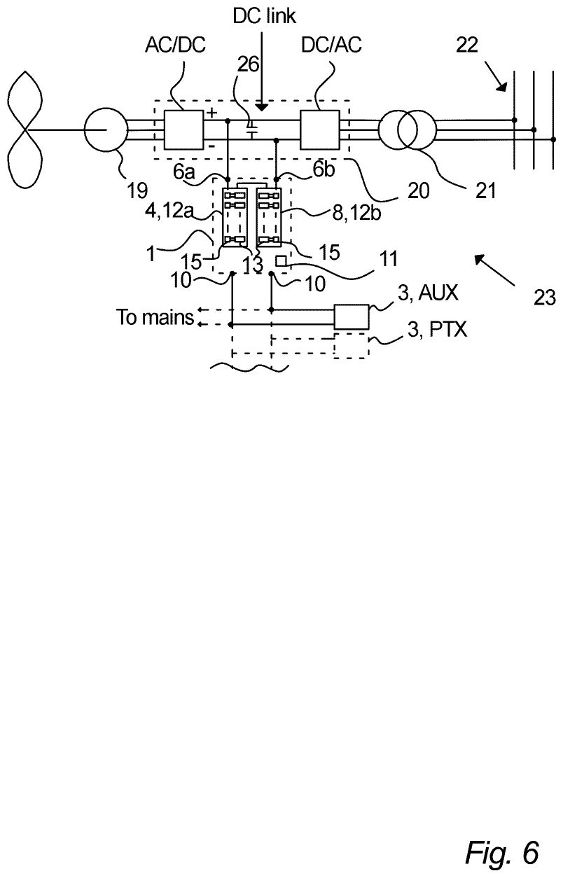

Thus, in embodiments, the power converter 20 of a wind turbine (or of a solar system) may, via the DC link, be connected to the converter 1 without the transformer 7. A converter 1 without the transformer 7, would also be able to facilitate pre-charge of the DC link capacitors and also of loads, such as electrolysers connected to the converter 1. This is at least true if the converter 1, as illustrated in FIG. 6, comprises two battery strings 12 connected in series between the negative and the positive pole of the power converter 20 DC link. In this way, the voltage of the two (or more) battery strings 12 may meet the DC link voltage limit and no transformer 7 is needed for this purpose. The DC link voltage limit should be understood as the voltage required to facilitate a flow of current from the converter to the DC link and thereby pre-charge the DC link capacitor 26.

Note that one string may be sufficient if the voltage of the battery modules hereof could sum up to an output voltage matching the DC link voltage limit which is typically in the around 1000V±1V-200V.

In a specific implementation of the DCDC converter 1 if several battery strings 12 are used for back up parts of the wind turbine 23. These battery strings could be used to provide power into the dc link of either the main converter 20 or for a dedicated PTX converter. In this situation, the technical challenge is that the dc link of the converter 20 may be 1100V and the battery string(s) 12 would be able to establish e.g. 7-800V. Therefore, the DCDC converter is needed to boost the voltage i.e. functioning as a boost converter or alternative two or more battery strings 12 would need to be connected in series. Further, when power flow is changed towards the power source 2, the DCDC converter 1 functions as a buck converter. Hence, the DCDC converter 1 is a bidirectional converter.

As mentioned, a DC link voltage of e.g. 1000V or 1100V may be delivered by connecting two or more battery string 12, comprising battery modules 13 controlled by one or more battery string controllers 17, in series. Thereby enabling a controllable maximum output voltage determined by the voltage of the individual of the series connected battery modules. This may be implemented using a high frequency transformer 7 and then a passive rectifier on the primary side 7a i.e. as the first converter module 4 in this example. On secondary side 7b, battery strings 12 may be used in that these can be controlled in a desired way to provide the needed/required voltage including a high frequency AC for the transformer 7.

By implementing the first converter module 4 as battery modules 13/strings 12, it is possible to establish a proper AC signal with e.g. 1000 Hz with steps of 50V (battery module voltage) instead of steps of a few hundred volts (i.e. a square wave signal).

Further, this implementation may also be advantageous in that power generated when the rotor is rotating without the wind turbine being in a power producing mode can be harvested and used for charging the battery modules 13 from the main converter 20 and its DC link without use of any additional hardware.

Further, this implementation may also be advantageous in that the DCDC converter may be able to smoothen power or to assist in frequency regulation of the grid.

FIG. 6 illustrates the converter 1 in an embodiment where the converter 1 is connected to the DC link of a power converter 20 of a wind turbine 23 via a first set of terminals 6. The wind turbine generator 19 is, as in FIG. 5, connected to the grid 22 via the power converter 20. The power converter 20 comprises a rectifier (AC/DC generator side converter) for rectifying the AC voltage from the generator 19 to the DC link voltage measured between the negative and positive potentials of the DC link. Between these potentials, a DC link capacitor 26 is illustrated. Further, the power converter 20 comprises an inverter (DC/AC grid side converter) converting the DC voltage of the DC link to an AC voltage. The AC voltage is supplied to a transformer 21 and further to the grid 22.

The first and second converter modules 4, 8 are in this embodiment illustrated as battery strings 12. As illustrated, the battery strings 12 are connected in series with the DC link. This is because, individually, the two illustrated battery string 12 is not able to supply sufficient voltage to pre-charge the DC link capacitor 26 which as mentioned could require a voltage of e.g. 1100V.

These battery strings 12 may be independently controllable by not illustrated controller/string controllers as described above and in addition to be used as part of the converter 1, the battery strings may be used for backup supply of different components of the wind turbine. This include, but are not limited to pitch, yaw, controllers, heaters, lights, etc.

Since two battery strings 12 are connected in series, the DC link voltage can be reached without the high frequency transformer 7 which is therefore not illustrated in the embodiment illustrated in FIG. 6. The illustrated configuration of the converter 1, without a high frequency transformer 7, may not always be preferred in that grounding issues may occur due to the lack of galvanic separation of DC link from loads connected to the battery strings 12.

The two illustrated battery strings 12 may also act as backup power supply or as pre-charge supply for loads 3 connected to the converter 1 via second set of terminals 10. Note that these loads do not need to be DC loads for the battery strings to supply/support them as the battery strings 12 can output both AC and DC voltage (one string AC or DC, not both simultaneously). Also as illustrated by stipulated lines and the text “to mains” the loads 3 may also be supplied by the electric system of the wind turbine i.e. from the generator 19 or from the grid 22 or electric connections therebetween.

The following features and advantages hereof may also be obtained with the converter 1 as describe above comprising a high frequency transformer 7 and at least the first converter module 4 connected to the DC link. This is at least true when the first converter module switching modules 5 are at least partly implemented as battery strings 12.

By connecting two battery strings 12 in series to the DC link positive and negative rail potentials as illustrated in FIG. 6 it is possible to pre-charge the DC link capacitor 26. Further, it is possible to keep the DC link voltage at a desired level such as the voltage level required for the power converter 20 to operate.

Compared to at least prior art wind turbine power conversion systems, this is advantageous in that hardware such as dedicated pre-charge circuits can be avoided. Hence, as a pre-charge circuit is no longer needed, the price of the power conversion system is reduced.

Further, even without the high frequency transformer it is possible, with the converter 1 illustrated in FIG. 6, to power the auxiliary system in case of start-up of the wind turbine without grid (also referred to as black start of the wind turbine).

Further, even without the high frequency transformer it is possible, with the converter 1 illustrated in FIG. 6, to magnetize the main transformer 21, pre-charge loads 3 such as an electrolyser and pre-charge DC link capacitor 26. This is advantageous in that inrush current when starting up the wind turbine can be reduced.

Further, even without the high frequency transformer it is possible, with the converter 1 illustrated in FIG. 6, to assist in starting up the generator 19, especially if the generator 19 is an induction generator.

Connection of battery strings 12 directly to the DC link of a power converter of a wind turbine as described above, also enable energy harvesting when the wind turbine is idling. Idling should be understood as when the rotor of a wind turbine is rotating due to a wind speed that is below cut-in speed. In this situation, the generator side converter (referred to a AC/DC rectifier above) could be used to rectify the voltage from the generator 19 and the battery strings 12 connected to the DC link, could then store the produced energy. In principle there are no lower limit for such energy harvesting other than the voltage level of the battery module of the battery strings 12 having the lowest voltage/state of charge. Such energy harvesting system is advantageous in that only the generator side of the power converter 20 need to be started. As the grid side of the power converter is not used it do not need to be powered up only the diodes (e.g. of the IGBT switches thereof need to be used) which would increase the efficiency of such energy harvesting system.

Further, in a wind turbine comprising a converter 1 as illustrated in FIG. 6, battery strings 12 directly connected to the DC link can assist in complying with grid codes e.g. in case of fault ride through situations. The battery strings 12 may store the excess energy produced e.g. during a low voltage ride through during the time where the wind turbine is disconnected from the grid. In the same way in case of a high voltage ride through, the battery storage may store or absorb the additional energy provided in such fault situation. In any event, using battery strings 12 for absorbing energy or supporting e.g. grid with energy during fault events or balancing events is advantageous in that cost may be saved in that hardware such as crowbar and other passive damping solutions may be superfluous. It should be noted that first converter module 4 of FIG. 5 may also facilitate this if implemented as one or more battery strings 12.

It should be noted, that if disconnected from the DC link, the battery strings 12, if the connection hereof to the battery strings is controlled by a battery switch module 15 comprising semiconductor switches in an H-bridge configuration, the battery strings 12 may supply an AC voltage to loads 3 or to the grid 22.

Thus, in other words FIG. 6 could be said to describe an energy converter such as a cascade H-bridge converter including internal energy storages 1 comprising a first battery string 12a and a second battery string 12b, the first battery string 12a comprising a plurality of battery switch modules 15 configured for controlling connection of a plurality of battery modules 13 to the first battery string 12a, the second battery string 12b comprising a plurality of battery switch modules 15 configured for controlling connection of a plurality of battery modules 13 to the second battery string 12b,

wherein a first terminal of the first battery string 12a is configured for being connected to a positive rail of a DC link of a power converter 20 of a wind turbine 23 via a first converter terminal 6a, wherein a second terminal of the first battery string 12a is connected to a first terminal of the second battery string 12b and wherein a second terminal of the second battery string 12b is configured for being connected to the negative rail of the DC link via a second converter terminal 6b (note that it may be the other way around i.e. the second battery string is connected to the positive DC potential and first battery string that is connected to the negative DC potential),
wherein a maximum sum of the voltage of the battery modules 13 of the first and second battery strings 12a, 12b is at least equal to a DC link voltage limit,
wherein the battery switch module 15 comprises at least two semiconductor switches 16 configured for controlling connectivity of the individual battery modules 13 to the first or second battery string 12a, 12b respectively, Note that it may be advantageous if such battery switch module 15 comprises four semiconductor switches in an H-bridge configuration in that both AC and DC and bidirectional current flow can be established,
wherein the output voltage of the first and second battery strings 12a, 12b is configured for being controlled by one or more battery string controllers 17, and
wherein the battery string controller 17 is configured for controlling the status of the four semiconductor switches 16 of the battery switch module 15.

In addition, as illustrated, the converter 1 illustrated in FIG. 6 may also comprise second converter terminals 10 configured for connecting loads 3 such as auxiliary loads and ptx loads such as electrolysers to the battery strings 12a, 12b. No electric connections are illustrated from the second converter terminals to the battery strings 12a, 12b but the configuration may be as described above e.g. with respect to FIGS. 3a and 3b. The supply to the battery strings 12a, 12b, may be from the DC link or from non-illustrated connections to other parts of the electrical system of the wind turbine. Note that on battery string may only be charged or discharged, not both at the same time. But if more than two strings are available two can be charged while two are discharged. Then at a point in time, they may switch so that the once being charge is not being discharged and vice versa.

The control of the switches 16 of the battery switch modules 15 is controlled by the string controller 17 or converter controller based on input from other controllers such as the string controller or converter controller or external controllers, based on input from DC link voltage sensor or similar.

In addition, the by having an energy converter 1 connected to the DC link of a renewable energy generator such as a wind turbine 23 makes it possible to perform dry out of the power converter 20 without grid connection. Hence, if the wind turbine has been inoperable for days e.g. during winter time, electric component such as transformer, generator, power converter and content of electric cabinets may suffer from moisture from condensation of ambient humidity. It is not desired to start-up e.g. a power converter when moistures in that hazardous situations or damage to the converter may occur. Such situations may occur e.g. because electric clearance distances are reduced in moistures environment. Hence, because of the battery modules 13 in the converter 1 it is possible to start the dry out days in advance of a planned grid connection if necessary. At least it is possible to have performed the dryout when there is no grid connection leading to production start at the moment of grid connection which increases availability of the wind turbine. The already existing preheat systems (part of auxiliary system) such as resistors and dehumidifier units could be powered from energy storage(s) of the converter 1.

Preheating may be provided e.g. be applying a voltage to the DC link such as between 1v and 500V (depending on time available for the dry out). If the voltage is a negative voltage applied to the negative DC link potential the diode bridge of the power module will conduct. The current will be controlled by the (typically only one) battery string needed and a close loop current control is established where current is circulated. Hence, the switching modules (e.g. IGBT modules) is heated first, but also transformer, generator, inductors, capacitors, etc. may be heated up this way. Accordingly, this way of heat could be referred to as an internal heating i.e. no ambient temperature of e.g. the power converter need to be heated first, to heat the components from outside and towards the critical components inside the components.

Dry out could also be facilitated by applying a positive voltage to the positive potential of the DC link. In this way assistance from the converter controller is needed to perform the dry out.

Further, note that, the dry out can also happen if there is grid. In this situation, the energy storage will help the grid so to speak heating up the components from the inside. Thus, the grid may supply a resistor that heats up the cooling system e.g. for a converter and heat up the converter in that way. Accordingly, with the help of the energy storage the components will heat up internally and must probably reduce the dry out time and energy used for dry out.

From the above it is now clear that the invention relates to an energy converter in the form of a cascaded H-bridge converter with energy modules or in the form of a DCDC converter. Independent of implementation, the energy converter is connectable to a main supply either directly or via a rectifier 25. The DCDC converter implementation comprise a first converter module 4 implemented as rectifiers, switches or battery modules 13, a high frequency transformer and a second converter module 8 implemented as rectifiers, switches or battery modules 13. It should be noted that one of the first and second converter modules 4, 8 should be implemented as battery modules 13. The cascaded H-bridge converter implementation comprise a first converter module 4 implemented as one or more battery strings and a second converter module 8 implemented as one or more battery strings where the two converter moules 4, 8, are connected in series. Hence, in one embodiment, the DCDC converter is a version of the cascaded H-bridge implementation where the two converter modules 4, 8 are connected via a transformer 7.

If not all, then most of the features described above in relation to the DCDC converter 1 may also apply to the cascaded H-bridge converter implementation hence a reference to the DCDC converter is a reference to the energy converter and in most cases a reference also to the cascaded H-bridge converter implementation. With this said, it should be noted, that in the transformer required AC, so to include the transformer 7 between the two converter modules 4, 8, the battery switch modules 15 should be implemented as H-bridges i.e. having four switches. Thus, the energy converter may work as backup supply e.g. for an AUX system of a wind turbine, as supply for a PTX module or both. The energy converter may also act as source to its main supply thereby assist in grid support activities.

Further, the energy converter may work as power source in case e.g. a wind turbine needs a black start. In case e.g. a renewable energy generator comprising the DCDC converter 1, such renewable energy generator may assist in black start of the utility grid/local grid.

The invention has been exemplified above with the purpose of illustration rather than limitation with reference to specific examples of the energy converter and implementation/design hereof. Details such as a specific method and system structures have been provided in order to understand embodiments of the invention. Note that detailed descriptions of well-known systems, devices, circuits, and methods have been omitted so as to not obscure the description of the invention with unnecessary details.

### LIST

1. Energy converter, DCDC converter, Cascaded H-bridge converter with energy storage
2. DC power source
3. DC load (electric loads such as AC or DC loads)
4. First converter module
5. First converter module switching module
6. First set converter terminals
   a. first converter terminal
   b. second converter termial
7. High frequency transformer
   a. Primary side
   b. Secondary side
8. Second converter module
9. Second converter module switching module
10. Second set of converter terminals
11. Converter controller
12. Battery string
13. Battery modules
14. Battery cell
15. Battery switch module
16. Semiconductor switches
17. Battery string controller
18. Additional electric components
   a. Capacitor
   b. Inductor
19. Generator
20. Power converter
21. Transformer
22. Grid
23. Wind turbine
24. Rectifier
25. Battery pack
26. DC link capacitor

1.-53. (canceled)

54. An energy converter comprising:
a first battery string and a second battery string, the first battery string including a plurality of battery switch modules configured for controlling connection of a plurality of battery modules to the first battery string, and the second battery string including a plurality of battery switch modules configured for controlling connection of a plurality of battery modules to the second battery string,
wherein a first terminal of the first battery string is configured for being connected to a positive rail of a DC link of a power converter of a renewable energy generator via a first converter terminal,
wherein a second terminal of the battery string is connected to a first terminal of the second battery string,
wherein a second terminal of the second battery string is configured for being connected to a negative potential of the DC link via a second converter terminal,
wherein a maximum sum of a voltage of the battery modules of the first and second battery strings is at least equal to a DC link voltage limit,
wherein the battery switch module comprises at least two semiconductor switches configured for controlling connectivity of individual battery modules to the first or second battery string respectively,
wherein a battery string controller is configured for controlling a status of the at least two semiconductor switches of the battery switch module, and
wherein an output voltage of the first and second battery strings is configured for being controlled by one or more battery string controllers.

55. The energy converter according to claim 54, wherein said energy converter is a cascaded h-bridge converter with energy storage.

56. The energy converter according to claim 54, wherein:
the energy converter is a DCDC converter, and
the DCDC converter is configured for connecting one or more DC power sources to one or more electric loads such as one or more DC loads, the DCDC converter including:
a first converter module includes a plurality of first converter switching modules configured for connecting a first set of converter terminals to a first side of a high frequency transformer, and
a second converter module includes one or more second converter switching modules each electrically connected a second side of said high frequency transformer, the one or more second converter switching modules being electrically connected to at least one second converter terminal set, and
a converter controller configured for controlling said first and second converter switching modules, and
wherein:
at least one converter switching module of at least one of said first and second converter modules is implemented as a one or more battery strings,
the one or more battery strings each comprises a plurality of series connected battery modules,
the battery modules comprising a plurality of connected battery cells and a battery switch module,
the battery switch module comprises at least two semiconductor switches configured for controlling connectivity of said battery module to said battery string, and
the battery string controller is configured for controlling said four semiconductor switches of said battery switch module.

57. The energy converter according to claim 56, wherein at least one of said one or more second converter switching modules are implemented as the one or more battery strings.

58. The energy converter according to claim 56, wherein said first converter module comprises a first, second, third and fourth first converter switching modules.

59. The energy converter according to claim 56, wherein said at least one converter switching module includes the first converter module,
wherein said first converter module is comprised by a wind turbine, and
wherein an existing battery string of said wind turbine is used as said at least one converter switching module.

60. The energy converter according to claim 56, wherein said second converter switching module is a battery string configured as power backup for an auxiliary system.

61. The energy converter according to claim 56, wherein said second set of converter terminals are connected to an auxiliary system.

62. The energy converter according to claim 54, wherein said first converter module is connected to a DC link of power converter of a wind turbine and configured for being controlled by said converter controller to supply power to said DC link.

63. The energy converter according to claim 54, wherein said energy converter is configured for connecting a DC power source having a positive and a negative potential to a plurality of power-to-x modules.

64. The energy converter according to claim 54, wherein a sum of battery string voltage of said one or more battery strings correspond to a DC power source.

65. The energy converter according to claim 54, wherein said second converter module is a DC source leading to said first converter module is connected to a DC load.

66. The energy converter according to claim 54, wherein said first converter module is configured to convert a DC voltage from a DC power source to an AC voltage supply to a primary side of a high frequency transformer.

67. The energy converter according to claim 54, wherein said second converter module is configured to convert an AC voltage from a secondary side of a high frequency transformer to a plurality of individually controllable DC voltage supplies to a plurality of electrolyser modules.

68. The energy converter according to claim 54, wherein a fuel cell is electrically connected to said second converter module switching module, thereby being able to feed power back to said first converter module.

69. The energy converter according to claim 54, wherein a converter controller is configured for providing control reference signals to one or more string controllers, and wherein said one or more string controllers are configured for controlling switching modules of said first converter module and of said second converter module.

70. A method of controlling a DCDC converter connecting a DC power sources to one or more DC loads via a high frequency transformer, said DCDC converter comprising:
a first converter module including at least two individually controllable battery modules electrically connecting said DC source to a first side of said high frequency transformer,
a second converter module including a battery string including a plurality of individually controllable battery modules electrically connecting said one or more DC loads to a second side of said high frequency transformer,
a converter controller providing control references to a string controller based on which said string controller is controlling connectivity of said plurality of battery modules of said second converter modules to said battery string,
wherein said connectivity is established by controlling semiconductor switches in a battery switch module of the individual battery module of said plurality of battery modules.

71. The method according to claim 70, wherein said string controller enable control charge of a DC link to any voltage between 0 and maximum battery string voltage.

72. The method according to claim 70, wherein at least battery modules of said first converter module is charged from a DC link during idle mode of a wind turbine.

73. A DCDC converter configured for connecting one or more DC power sources to one or more DC loads, said DCDC converter comprising:
a first converter module comprising a plurality of first converter module switching modules configured for connecting a first set of converter terminals to a first side of a high frequency transformer;
a second converter module comprising one or more second converter switching modules each electrically connected a second side of said high frequency transformer, the one or more second converter switching modules being electrically connected to at least one second converter terminal set; and
a converter controller configured for controlling said first and second converter switching modules,
wherein at least one converter switching module of at least one of said first and second converter modules is implemented as a one or more battery strings,
wherein said one or more battery strings each comprises a plurality of series connected battery modules,
wherein said battery modules comprising a plurality of connected battery cells and a battery switch module,
wherein said battery switch module comprises at least two semiconductor switches configured for controlling connectivity of said battery module to said battery string, and
wherein a battery string controller is configured for controlling said four semiconductor switches of said battery switch module.
